(19) United States
(12) Patent Application Publication
(10) Pub. No.: US 2012/0237316 A1
(43) Pub. Date: Sep. 20, 2012

(54) FLOATING FASTENER

(76) Inventor: MING-CHUNG CHIU, New Taipei City (TW)

(21) Appl. No.: 13/050,497

(22) Filed: Mar. 17, 2011

(51) Int. Cl. F16B 21/18

(52) U.S. Cl. 411/353

(57) ABSTRACT

A floating fastener includes a mounting socket bonded to a first plate member, a locking member axially movably mounted in the mounting socket and fastenable to a second plate member to lock the first plate member to the second plate member, a first locating ring mounted in the mounting socket around a plain stem of the locking member and adapted for securing a shoulder of the locking member to hold the locking member in a received position temporarily, a spring member mounted around the locking member in the mounting socket and stopped between a head of the locking member and the first locating ring to support the locking member in a floating position, and a second locating ring mounted in the mounting socket to prohibit the locking member from falling out of the mounting socket.

### BACKGROUND OF THE INVENTION

1. Field of the Invention

The present invention relates to fasteners for joining metal plate members and more particularly, to a floating fastener, which uses a first locating ring to temporarily secure a locking member in a received position in a mounting socket thereof and a second locating ring to prohibit the locking ring from escaping out of the mounting socket, facilitating installation.

2. Description of the Related Art

When fastening plate members together, positioning screws that are each formed of a knob, a ring and a screw nail are usually used. During installation, the screw nail and the ring are secured to the first plate member, and then the knob is rotated to drive the screw nail into the second plate member, and then a hand tool is used to fasten tight the screw nail, affixing the first and second plate members together. This plate member joining method can be used in a machine tool to join plate members together. The power drive and speed-adjustment unit of a machine tool are generally provided inside the housing. However, during a mounting or dismounting operation, the screw nails may be lost accidentally, causing installation problems.

To facilitate detachable installation and to avoid missing component parts, floating captive screws are created. FIG. 14 illustrates a floating captive screw according to the prior art. According to this design, the floating captive screw comprises a mounting socket A, a lock screw B floating in the mounting socket A, a spring member A1 sleeved onto the lock screw B and stopped between a mounting flange A2 around the periphery of the mounting socket A and a head B1 of the lock screw B, a stop member A3 mounted inside the mounting socket A, and a screw nut C threaded onto a threaded shank B2 of the lock screw B after insertion of the threaded shank B2 of the lock screw B through the stop member A3 and a inside chamber A0 of the mounting socket A. Further, the mounting socket A has a bottom bonding end A4 for bonding to a plate member D.

This design of floating captive screw is still not satisfactory in function, and has drawbacks as follows:

1. Because floating captive screw consists of the mounting socket A, the spring member A1, the stop member A3, the lock screw B and the screw nut C, it is expensive to manufacture and complicates to install, wasting much labor and time in installation.

2. The bottom bonding end A4 of the mounting socket A is not deeply inserted into the mounting though hole on the plate member D for bonding. When fastening or unfastening the lock screw B, the mounting socket A may be vibrated and forced away from the plate member D accidentally.

Therefore, it is desirable to provide a floating fastener that eliminates the drawbacks of the aforesaid prior art design that consists of a great number of component parts, tends to be disconnected from the connected plate member, and requires much time and labor during installation.

### SUMMARY OF THE INVENTION

The present invention has been accomplished under the circumstances in view. It is therefore an object of the present invention to provide a floating fastener, which uses a first locating ring to temporarily secure a locking member to a mounting socket thereof in a received position and a second retaining member to prohibit the locking ring from escaping out of the mounting socket, facilitating installation.

To achieve this and other objects of the present invention, a floating fastener consists of a mounting socket, a locking member, a first locating ring, a spring member and a second locating ring. The mounting socket has a bottom mounting portion for bonding to a first metal plate member. The locking member is axially movably mounted in an open chamber in the mounting socket, having a head, a shoulder, a plain stem and a fastening end piece integrally arranged in series. The first locating ring and the second locating ring are mounted in the mounting socket at different elevations around the plain stem of the locking member. The spring member is sleeved onto the locking member and stopped between the head of the locking member and the first locating ring to support the locking member in the mounting socket in a floating position. The shoulder of the locking member can be secured to the first locating ring temporarily to hold the locking member in a received position. The second locating ring is stopped above the fastening end piece of the locking member to prohibit the locking member from falling out of the mounting socket.

By means of forcing the locking member downwardly to force the shoulder into the first locating ring, the locking member is temporarily secured to the first locating ring in the received position. When biasing the locking member, the shoulder is disengaged from the first locating ring, and the spring member immediately returns the locking member from the received position to the floating position.

Further, the locking member comprises a first locating groove and a second locating groove disposed in the open chamber at different elevations. The first locating ring and the second locating ring are respectively mounted in the first locating groove and the second locating groove in the mounting socket.

Further, the shoulder of the locking member is embossed, or processed to provide a pattern of teeth, ribs or raised portions, enhancing friction with the first locating ring.

Further, a cap member may be capped on the head of the locking member, facilitating operating the locking member.

### BRIEF DESCRIPTION OF THE DRAWINGS

FIG. 1 is an elevational view of a floating fastener in accordance with a first embodiment of the present invention.

FIG. 2 is an exploded view of the floating fastener in accordance with the first embodiment of the present invention.

FIG. 3 is a sectional assembly view of the first embodiment of the present invention before installation of the floating fastener in a first metal plate member.

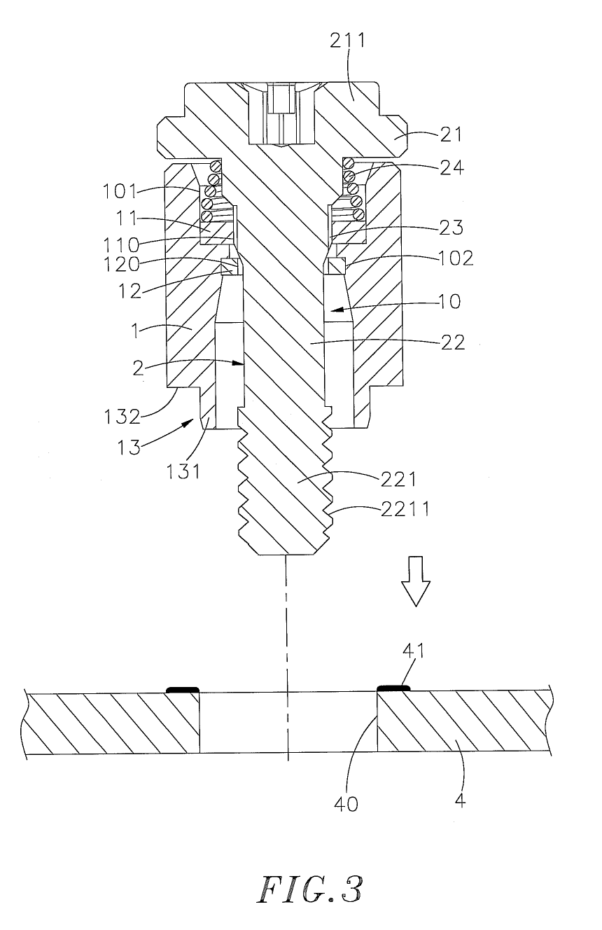

FIG. 4 corresponds to FIG. 3, illustrating the floating fastener bonded to a first metal plate member before fixation to a second metal plate member.

FIG. 5 corresponds to FIG. 4, illustrating the shoulder of the locking member disengaged from the first locating ring.

FIG. 6 corresponds to FIG. 5, illustrating the locking member threaded into the mounting screw hole of the second metal plate member.

FIG. 7 is an exploded view of a floating fastener in accordance with a second embodiment of the present invention.

FIG. 8 is a sectional side view of FIG. 7.

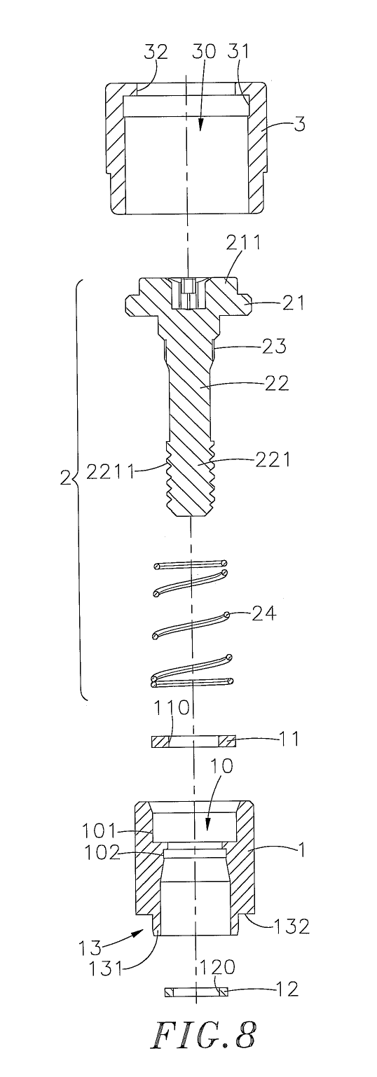

FIG. 9 is a schematic sectional view of the second embodiment of the present invention, illustrating the floating fastener installed in a first metal plate member before fixation to a second metal plate member.

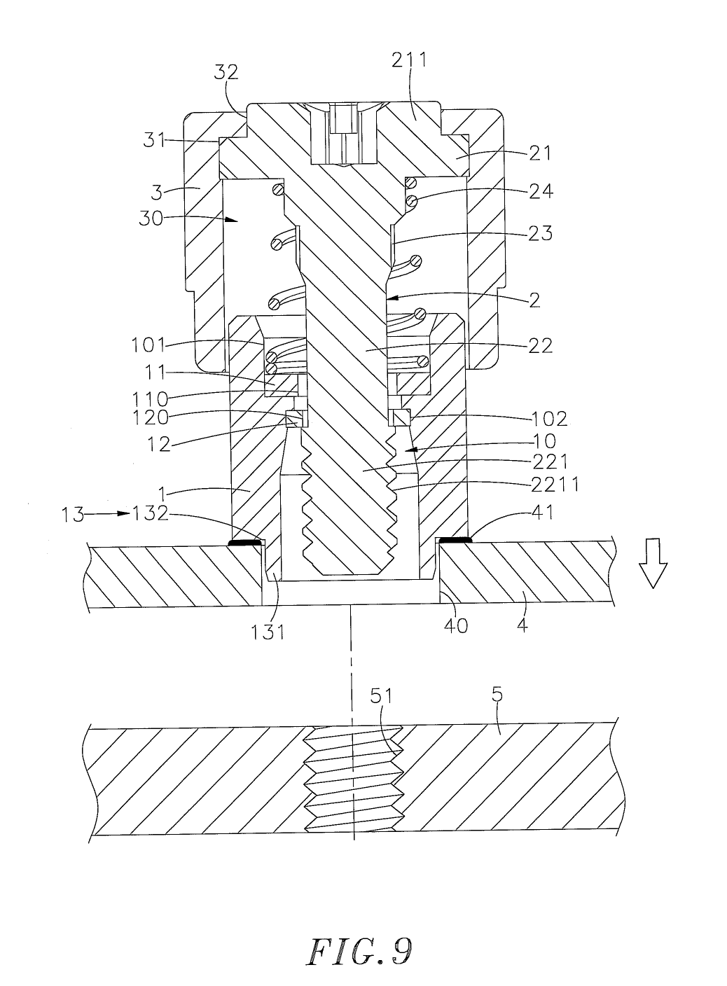

FIG. 10 is an exploded view of a floating fastener in accordance with a third embodiment of the present invention.

FIG. 11 is a sectional assembly view of the floating fastener in accordance with the third embodiment of the present invention.

FIG. 12 is an exploded view of a floating fastener in accordance with a fourth embodiment of the present invention.

FIG. 13 is a sectional assembly view of the floating fastener in accordance with the fourth embodiment of the present invention.

FIG. 14 is a sectional view of a floating captive screw according to the prior art.

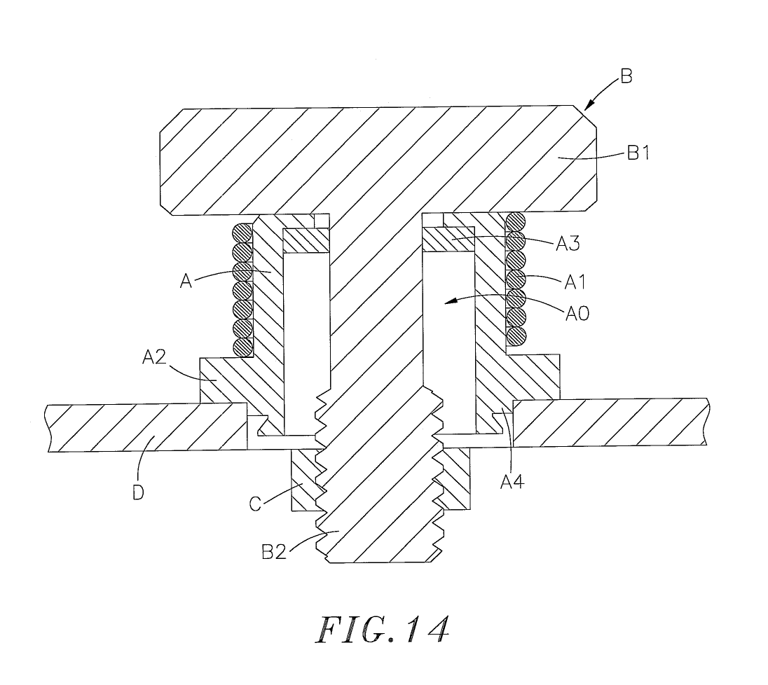

### DETAILED DESCRIPTION OF THE PREFERRED EMBODIMENT

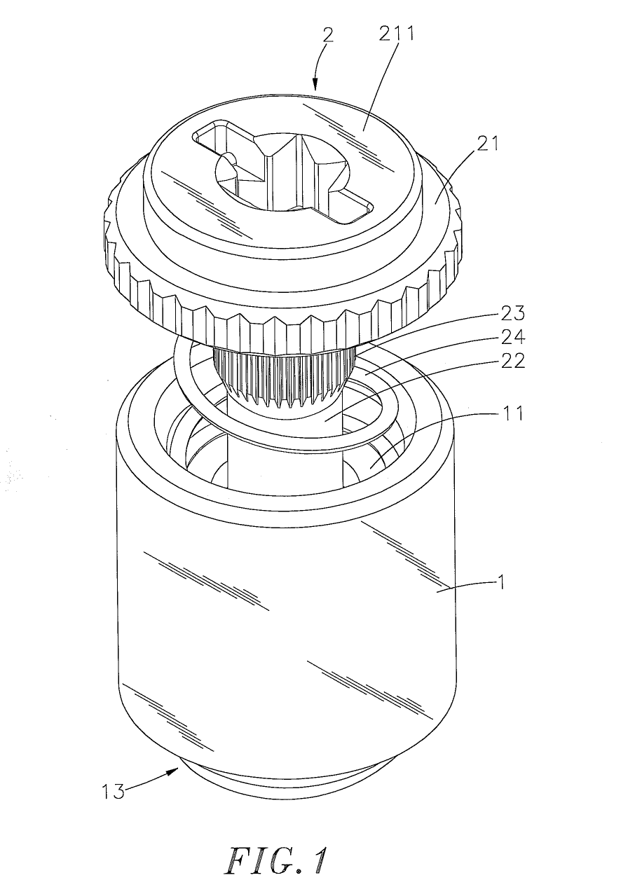

Referring to FIGS. 1˜4, a floating fastener in accordance with a first embodiment of the present invention is shown comprising a mounting socket 1, a locking member 2, a first locating ring 11, a second locating ring 12 and a spring member 24.

The mounting socket 1 comprises an open chamber 10, a first annular locating groove 101 disposed in the open chamber 10 near a top side thereof, a second annular locating groove 102 disposed in the open chamber 10 and spaced below the first annular locating groove 101, and a bottom mounting portion 13 defining a horizontally extending bonding face 131 and a vertically extending mounting neck 132.

The first locating ring 11 is a resilient or elastic member, for example, a snap ring mounted in the first annular locating groove 101 in the open chamber 10 of the mounting socket 1, defining therein a retaining hole 110.

The second locating ring 12 is a resilient or elastic member, for example, a snap ring mounted in the second annular locating groove 102 in the open chamber 10 of the mounting socket 1, defining therein a retaining hole 120.

The locking member 2 comprises a head 21, a tool-driving device 211 located on the top wall of the head 21, a fastening end piece 221, a plain stem 22 connected between the head 21 and the fastening end piece 221, a shoulder 23 connected between the head 21 and the plain stem 22. According to this embodiment, the locking member 2 is a lock screw, and the fastening end piece 221 carrying an outer thread 2211.

The spring member 24 is sleeved onto the fastening end piece 221, plain stem 22 and shoulder 23 of the locking member 2 and inserted with the fastening end piece 221, plain stem 22 and shoulder 23 of the locking member 2 into the mounting socket 1, and stopped between the head 21 of the locking member 2 and the first locating ring 11 in the mounting socket 1.

When assembling the component parts of the floating fastener, insert the fastening end piece 221 and plain stem 22 of the locking member 2 into the retaining hole 110 of the first locating ring 11 and the retaining hole 120 of the second locating ring 12 by force to force the shoulder 23 of the mounting socket 1 into the retaining hole 110 of the first locating ring 11 and to compress the spring member 24 between the head 21 of the locking member 2 and the first locating ring 11.

As illustrated, the first annular locating groove 101 and the second annular locating groove 102 are disposed in the open chamber 10 of the mounting socket 1 at different elevations; the first locating ring 11 and the second locating ring 12 are respectively mounted in the first annular locating groove 101 and the second annular locating groove 102 at different elevations in the open chamber 10 of the mounting socket 1. When the fastening end piece 221 and plain stem 22 of the locking member 2 are forced through the retaining hole 110 of the first locating ring 11 and the retaining hole 120 of the second locating ring 12, the shoulder 23 of the locking member 2 is forced into the retaining hole 110 of the first locating ring 11 and temporarily secured to the first locating ring 11.

Further, the shoulder 23 is peripherally coarsened to enhance friction against the first locating ring 11. For example, the shoulder 23 can be embossed, or made to provide fine teeth, ribs or raised portions in a regular or irregular array. Thus, the shoulder 23 can be positively and temporarily secured to the retaining hole 110 of the first locating ring 11 and conveniently disengageable from the first locating ring 11 through a rotary motion. Further, the locking member 2 can be a lock screw or lock pin. According to this embodiment, the locking member 2 is a lock screw. The maximum outer diameter of the fastening end piece 221 is greater than the diameter of the retaining hole 120 of the second locating ring 12. After the shoulder 23 of the locking member 2 is inserted through the retaining hole 120 of the second locating ring 12 by force, the second locating ring 12 immediately returns to its former shape and slidably secured to the plain stem 22 of the locking member 2 above the fastening end piece 221. Thus, the locking member 2 can be moved axially relative to the mounting socket 1 and will not fall from the mounting socket 1.

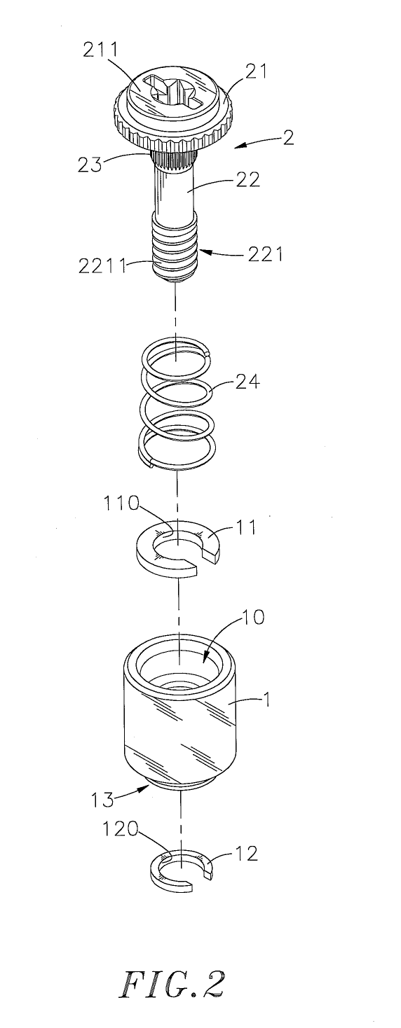

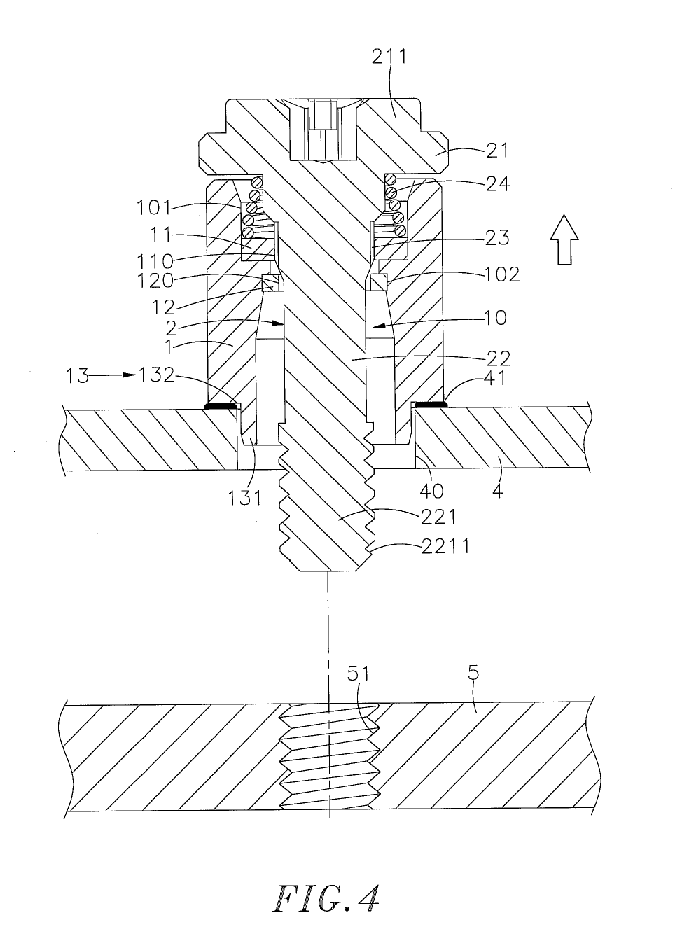

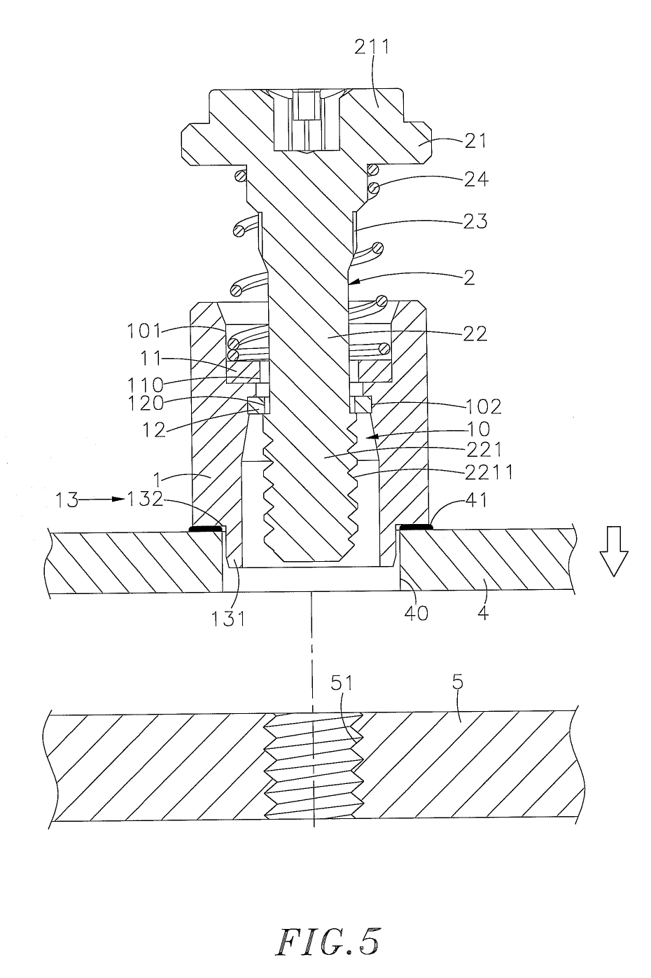

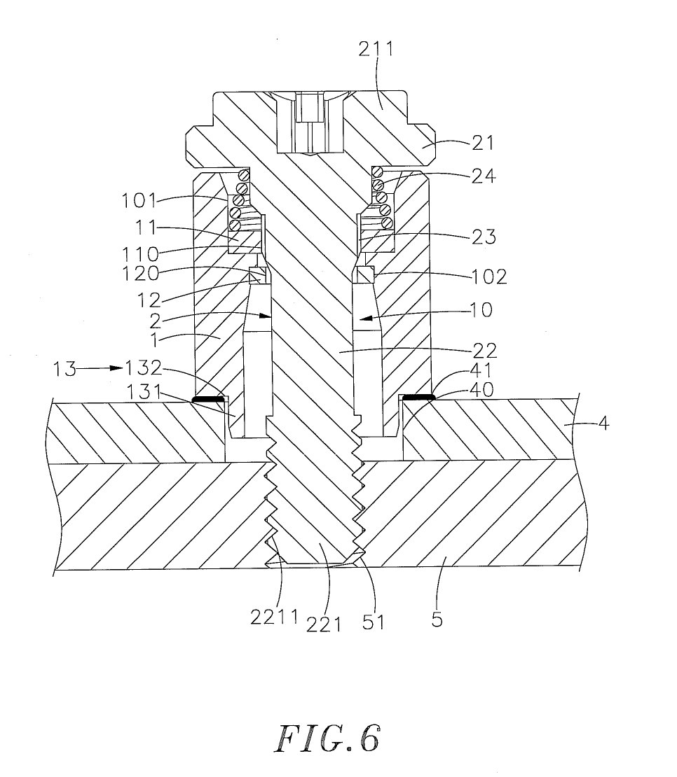

Referring to FIGS. 5 and 6 and FIGS. 2 and 4 again, when the floating fastener is assembled, the shoulder 23 of the locking member 2 is temporarily secured to the retaining hole 110 of the first locating ring 11, and the fastening end piece 221 of the locking member 2 is suspending outside the mounting socket 1. During installation, insert the vertically extending mounting neck 132 of the bottom mounting portion 13 into a mounting through hole 40 of a first metal plate member 4 and stop the horizontally extending bonding face 131 of the bottom mounting portion 13 at a solder paste 41 being applied to the top surface of the first metal plate member 4 around the mounting through hole 40, and then apply a bonding technique (reflow soldering or spot welding technique) to fixedly fasten the mounting socket 1 to the first metal plate member 4. After the mounting socket 1 is affixed to the first metal plate member 4, rotate the locking member 2 to disengage the shoulder 23 from the retaining hole 110 of the first locating ring 11, enabling the locking member 2 to be pushed upwardly outwards relative to the mounting socket 1 by the spring member 24 to let the fastening end piece 221 of the locking member 2 be stopped at the bottom side of the second locating ring 12. Thus, the locking member 2 is floating in the mounting socket 1.

When rotating the locking member 2, the first locating ring 11 is forced by the non-circular periphery of the shoulder 23 to expand the retaining hole 110, enabling the shoulder 23 to be moved axially away from the retaining hole 110 and released from the constraint of the first locating ring 11.

After installation of the floating fastener in the first metal plate member 4, the first metal plate member 4 can be attached to a second metal plate member 5 and locked thereto by the floating fastener. When the first metal plate member 4 is attached to the second metal plate member 5, the mounting through hole 40 of the first metal plate member 4 is kept in axial alignment with a mounting screw hole 50 on the second metal plate member 5, and then the locking member 2 is forced downwards and rotated to thread the outer thread 2211 of the fastening end piece 221 into the mounting screw hole 50, thereby locking the first metal plate member 4 to the second metal plate member 5.

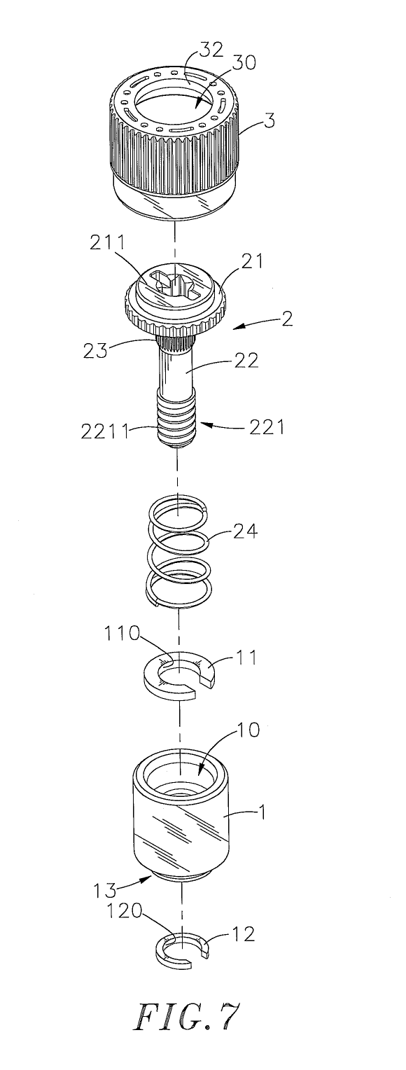

FIGS. 7˜9 illustrate a floating fastener in accordance with a second embodiment of the present invention. This second embodiment is substantially similar to the aforesaid first embodiment with the exception of an extra cap member 3. The cap member 3 defines a bottom-open chamber 30, a top center opening 32 in communication with the bottom-open chamber 30, and a locating groove 31 extending around the inside wall thereof in the bottom-open chamber 30 and adjacent to the top center opening 32. The cap member 3 is attached to the locking member 2 to force the locating groove 31 and the tool-driving device 211 into friction engagement with the head 21 of the locking member 2. Further, the periphery of the head 21 of the locking member 2 is embossed, or processed to provide teeth, threads, ribs or raised portions, enhancing friction. Further, the bottom-open chamber 30 has a diameter greater than the outer diameter of the mounting socket 1 so that the cap member 3 can be covered on the mounting socket 1. Further, the tool-driving device 211 of the locking member 2 can be a Phillips groove, keystone groove, asterisk groove, hex groove, or any other design of tool groove for driving by a Phillips-tip screwdriver, keystone-tip screwdriver, asterisk-tip screwdriver, hex-tip screwdriver, or any other matching design tool.

During application of this second embodiment, insert the vertically extending mounting neck 132 of the bottom mounting portion 13 into a mounting through hole 40 of a first metal plate member 4 and stop the horizontally extending bonding face 131 of the bottom mounting portion 13 at a solder paste 41 being applied to the top surface of the first metal plate member 4 around the mounting through hole 40, and then apply a bonding technique (reflow soldering or spot welding technique) to fixedly fasten the mounting socket 1 to the first metal plate member 4. After the mounting socket 1 is affixed to the first metal plate member 4, rotate the locking member 2 to disengage the shoulder 23 from the retaining hole 110 of the first locating ring 11, enabling the locking member 2 to be pushed upwardly outwards relative to the mounting socket 1 by the spring member 24 to let the fastening end piece 221 of the locking member 2 be stopped at the bottom side of the second locating ring 12. Thus, the locking member 2 is floating in the mounting socket 1. After installation of the floating fastener of this second embodiment in the first metal plate member 4, the first metal plate member 4 can be attached to a second metal plate member 5 and locked thereto by the locking member 2 of the floating fastener.

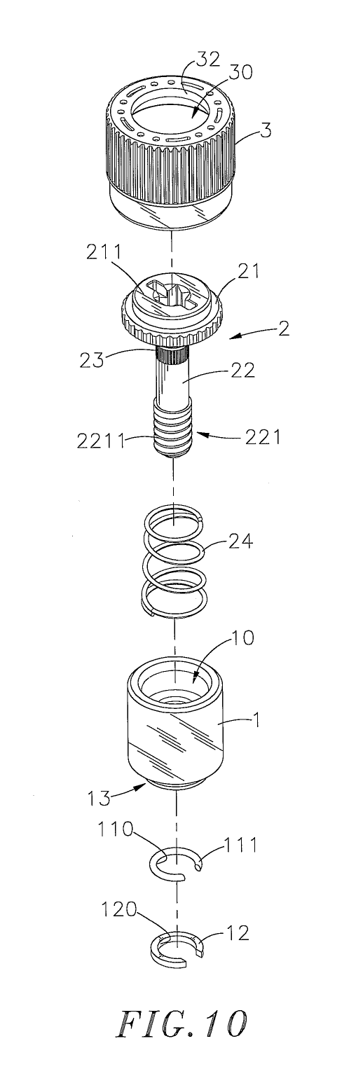

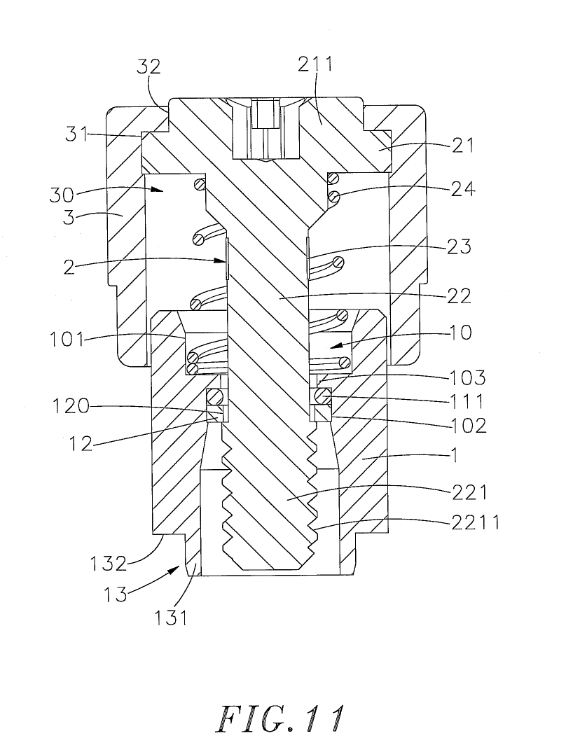

FIGS. 10 and 11 illustrate a floating fastener in accordance with a third embodiment of the present invention. This third embodiment is substantially similar to the aforesaid second embodiment with exception of the design of the mounting socket 1 and the mounting arrangement of the first locating ring, referenced by 11, and the second locating ring 12 and the spring member 24 in the mounting socket 1. According to this third embodiment, the mounting socket 1 comprises an open chamber 10, an inside annular flange 103 transversely disposed in the open chamber 10, a first annular locating groove 101 disposed in the open chamber 10 at the bottom side of the inside annular flange 103, a second annular locating groove 102 disposed in the open chamber 10 and abutted against the bottom side of the first annular locating groove 101, and a bottom mounting portion 13 defining a horizontally extending bonding face 131 and a vertically extending mounting neck 132; a first locating ring 111 is a snap ring or C-shaped retainer (as shown in FIG. 2) mounted in the first annular locating groove 101 around the plain stem 22 of the locking member 2; the second locating ring 12 is a snap rings or C-shaped retainer (as shown in FIG. 2) mounted in the second annular locating groove 102 around the plain stem 22 of the locking member 2 and stopped at the top side of the fastening end piece 221 of the locking member 2; the spring member 24 is sleeved onto the plain stem 22 and shoulder 23 of the locking member 2 and stopped between the head 21 of the locking member 2 and the inside annular flange 103 of the mounting socket 1; the cap member 3 defines a bottom-open chamber 30, a top center opening 32 disposed in communication with the bottom-open chamber 30 and forced into engagement with the periphery of the tool-driving device 211 of the locking member 2, and a locating groove 31 extending around the inside wall thereof in the bottom-open chamber 30 and forced into friction engagement with the periphery of the head 21 of the locking member 2 tightly. When the floating fastener is assembled, the shoulder 23 of the locking member 2 is temporarily secured to the retaining hole 110 of the first locating ring 111, and the fastening end piece 221 of the locking member 2 is kept suspending outside the mounting socket 1. When rotating the locking member 2, the first locating ring 11 is forced by the non-circular periphery of the shoulder 23 to expand the retaining hole 110, enabling the shoulder 23 to be moved axially away from the retaining hole 110 and released from the constraint of the first locating ring 111. The floating fastener of this third embodiment can be installed in a first metal plate member to detachably lock the first metal plate member to a second metal plate manner in the same manner as the aforesaid first and second embodiments.

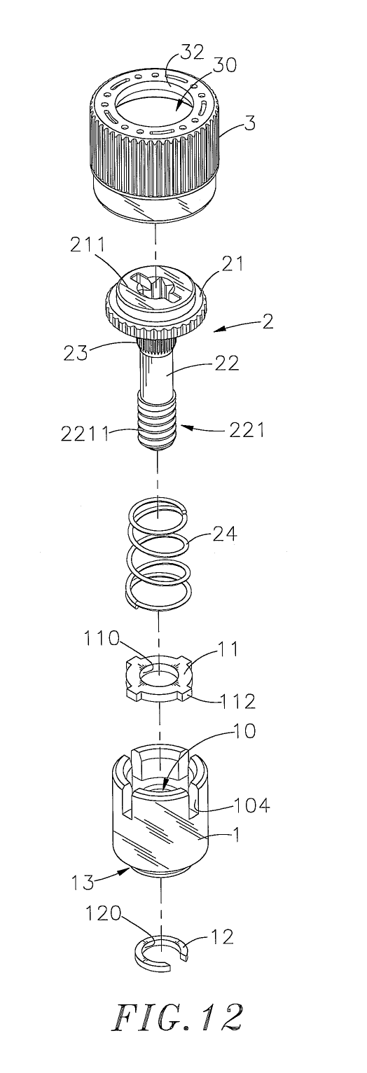

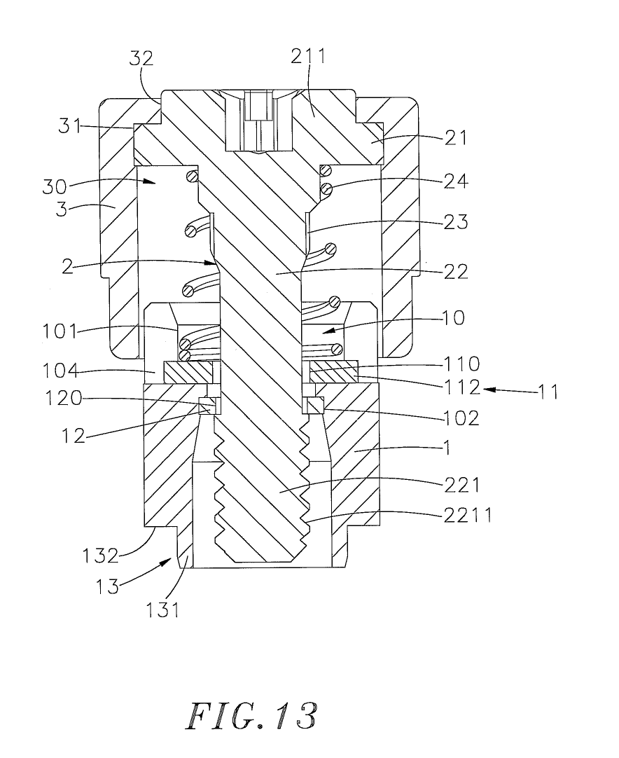

FIGS. 12 and 13 illustrate a floating fastener in accordance with a fourth embodiment of the present invention. According to this fourth embodiment, the floating fastener consists of a mounting socket 1, a first locating ring 11, a second locating ring 12, a locking member 2, a spring member 24 and a cap member 3. As illustrated, the mounting socket 1 comprises an open chamber 10, a first annular locating groove 101 disposed in the open chamber 10 near a top side thereof, a second annular locating groove 102 disposed in the open chamber 10 and spaced below the first annular locating groove 101, a plurality of elongated slots 104 spaced around the periphery and longitudinally extending to the topmost edge thereof, and a bottom mounting portion 13 defining a horizontally extending bonding face 131 and a vertically extending mounting neck 132; the locking member 2 comprises a head 21, a tool-driving device 211 located on the top wall of the head 21, a fastening end piece 221 having an outer thread 2211, a plain stem 22 connected between the head 21 and the fastening end piece 221, a shoulder 23 connected between the head 21 and the plain stem 22; the first locating ring 11 is an annular ring mounted in the first annular locating groove 101 in the open chamber 10 of the mounting socket 1 around the plain stem 22 of the locking member 2, having a retaining hole 110 defined therein for temporarily constraining the shoulder 23 of the locking member 2 and a plurality of radial rods 112 spaced around the periphery and respectively fitted into the elongated slots 104 of the mounting socket 1; the second locating ring 12 is a snap ring or C-shaped retainer mounted in the second annular locating groove 102 in the open chamber 10 of the mounting socket 1 around the plain stem 22 of the locking member 2 and stoppable at the top side of the fastening end piece 221, defining therein a retaining hole 120; the spring member 24 is sleeved onto the fastening end piece 221, plain stem 22 and shoulder 23 of the locking member 2 and stopped between the head 21 of the locking member 2 and the first locating ring 11 in the mounting socket 1; the cap member 3 defines a bottom-open chamber 30, a top center opening 32 disposed in communication with the bottom-open chamber 30 and forced into engagement with the periphery of the tool-driving device 211 of the locking member 2, and a locating groove 31 extending around the inside wall thereof in the bottom-open chamber 30 and forced into friction engagement with the periphery of the head 21 of the locking member 2 tightly. When the floating fastener is assembled, the shoulder 23 of the locking member 2 is temporarily secured to the retaining hole 110 of the first locating ring 11, and the fastening end piece 221 of the locking member 2 is kept suspending outside the mounting socket 1. When rotating the locking member 2, the first locating ring 11 is forced by the non-circular periphery of the shoulder 23 to expand the retaining hole 110, enabling the shoulder 23 to be moved axially away from the retaining hole 110 and released from the constraint of the first locating ring 11. The use and application of this fourth embodiment are same as the aforesaid various embodiments.

The above described embodiments are simply examples of the invention but not intended for us as limitations of the invention. In general, the invention provides a floating fastener, which comprises a mounting socket 1, which defines therein an open chamber 10, a locking member 2, which comprises a head 21, a tool-driving device 211 located on the top wall of the head 21, a fastening end piece 221, a plain stem 22 connected between the head 21 and the fastening end piece 221 and a shoulder 23 connected between the head 21 and the plain stem 22, a first locating ring 11 mounted in the mounting socket 1 around the plain stem 22 of the locking member 2 and adapted for securing the shoulder 23 of the locking member 2 temporarily to hold the locking member 2 in a received position, a second locating ring 12 mounted in the mounting socket 1 around the plain stem 22 of the locking member 2 and stopped at the top side of the fastening end piece 221 of the locking member 2 to prohibit the locking member 2 from falling out of the mounting socket 1, a spring member 24 sleeved onto the plain stem 22 and shoulder 23 of the locking member 2 and stopped between the head 21 of the locking member 2 and the first locating ring 12, and a cap member 3, which defines a bottom-open chamber 30, a top center opening 32 disposed in communication with the bottom-open chamber 30 and forced into engagement with the periphery of the tool-driving device 211 of the locking member 2 and a locating groove 31 extending around the inside wall thereof in the bottom-open chamber 30 and forced into friction engagement with the periphery of the head 21 of the locking member 2 tightly.

In actual application, the floating fastener has the advantages as follows:
1. The shoulder 23 of the locking member 2 can be temporarily secured to the first locating ring 11 in the mounting socket 1 so that the spring member 24 is kept compressed in the mounting socket 1, facilitating bonding the bottom mounting portion 13 of the mounting socket 1 to a mounting through hole 40 of a first metal plate member 4, avoiding vibration of the locking member 2 during the bonding process.
2. By means of inserting the vertically extending mounting neck 132 of the bottom mounting portion 13 of the mounting socket 1 into the mounting through hole 40 of the first metal plate member 4 and stopping the horizontally extending bonding face 131 of the bottom mounting portion 13 at a solder paste 41 being applied to the top surface of the first metal plate member 4 around the mounting through hole 40, the mounting socket 1 can then be positively and accurately bonded to the first metal plate member 4 by a bonding technique (reflow soldering or spot welding technique). After the mounting socket 1 is bonded to the first metal plate member 4, the first metal plate member 4 can be detachably fastened to the second metal plate member 5 by the locking member 2, and the mounting socket 1 will not fall out of the mounting through hole 40 of the first metal plate member 4 when the locking member 2 is being fastened to the second metal plate member 5.
3. A cap member 3 can be fastened to the head 21 of the locking member 2 to facilitating rotating the locking member 2. When the floating fastener is assembled, the shoulder 23 of the locking member 2 can be temporarily secured to the first locating ring 11 in the mounting socket 1 to keep the spring member 24 in a compressed condition. By means of rotating the locking member 2 to release the shoulder 23 from the constraint of the first locating ring 11, the locking member 2 and the cap member 3 become in a floating condition.

It is to be understood that the above-described embodiments of the invention are merely possible examples of implementations, merely set forth for a clear understanding of the principles of the invention, many modifications and enhancements may be made without departing from the spirit and scope of the invention. Accordingly, the invention is not to be limited except as by the appended claims.

What the invention claimed is:

1. A floating fastener mounted in a first plate member for detachably fastening said first plate member to a second plate member, comprising:
a mounting socket comprising an open chamber and a bottom mounting portion bonded to said first plate member;
a locking member axially movably mounted in said open chamber of said mounting socket and fastenable to said second plate member to lock said first plate member to said second plate member, said locking member comprising a head, a tool-driving device located on a top side of said head, a fastening end piece fastenable to said second plate member, a plain stem connected between said head and said fastening end piece and a shoulder connected between said head and said plain stem;
a first locating ring mounted in said open chamber of said mounting socket around said plain stem of said locking member and adapted for securing said shoulder of said locking member temporarily to hold said locking member in a received position where said fastening end piece extends out of said open chamber of said mounting socket and said spring member is compressed;
a spring member sleeved onto said locking member and received in said open chamber of said mounting socket and stopped between said head of said locking member and said first locating ring; and
a second locating ring mounted in said open chamber of said mounting socket around said plain stem of said locking member and below said first locating ring and stopped at a top side of said fastening end piece to prohibit said locking member from falling out of said mounting socket.

2. The floating fastener as claimed in claim 1, wherein said mounting socket comprises a first annular locating groove and a second annular locating groove disposed in said open chamber at different elevations for accommodating said first locating ring and said second locating ring respectively.

3. The floating fastener as claimed in claim 1, wherein said first locating ring is a snap ring defining therein an inner hole having a diameter greater than the outer diameter of said plain stem and the outer diameter of said fastening end piece and smaller than the outer diameter of said shoulder; said second locating ring is a snap ring defining therein an inner hole having a diameter greater than the outer diameter of said plain stem and smaller than the outer diameter of said fastening end piece.

4. The floating fastener as claimed in claim 1, wherein said first locating ring is a C-shaped retainer defining therein an inner hole having a diameter greater than the outer diameter of said plain stem and the outer diameter of said fastening end piece and smaller than the outer diameter of said shoulder; said second locating ring is a C-shaped retainer defining therein an inner hole having a diameter greater than the outer diameter of said plain stem and smaller than the outer diameter of said fastening end piece.

5. The floating fastener as claimed in claim 1, wherein said mounting socket comprises a plurality of elongated slots spaced around the periphery thereof an longitudinally extending to the topmost edge thereof; said first locating ring comprises a plurality of radial rods spaced around the periphery and respectively fitted into said elongated slots of said mounting socket.

6. The floating fastener as claimed in claim 1, wherein said shoulder of said locking member is peripherally embossed with a pattern of raised portions.

7. The floating fastener as claimed in claim 1, wherein said locking member is a lock screw comprising an outer thread extending around said fastening end piece.

8. The floating fastener as claimed in claim 1, wherein said locking member is a lock pin.

9. The floating fastener as claimed in claim 1, further comprising a cap member mounted on said head of said locking member.

10. The floating fastener as claimed in claim 9, wherein said cap member comprises a bottom-open chamber, a top center opening disposed in communication with said bottom-open chamber and forced into engagement with the periphery of said tool-driving device of said locking member and a locating groove extending around an inside wall thereof in said bottom-open chamber and forced into friction engagement with the periphery of said head of said locking member tightly.
